(19) United States
(12) Patent Application Publication
(10) Pub. No.: US 2013/0073700 A1
(43) Pub. Date: Mar. 21, 2013

(54) SYSTEM AND METHOD FOR SHARING INFORMATION BETWEEN HETEROGENEOUS SERVICE PROVIDERS

(71) Applicants: Dae Hee SEO, Chungcheongnam-do (KR); Gae II An, Daejeon (KR); Sung Won Yi, Daejeon (KR); Ki Young Kim, Daejeon (KR); Jong Hyun Kim, Daejeon (KR); Sun Hee Lim, Seongnam (KR); Dong II Seo, Daejeon (KR)

(72) Inventors: Dae Hee SEO, Chungcheongnam-do (KR); Gae II An, Daejeon (KR); Sung Won Yi, Daejeon (KR); Ki Young Kim, Daejeon (KR); Jong Hyun Kim, Daejeon (KR); Sun Hee Lim, Seongnam (KR); Dong II Seo, Daejeon (KR)

(73) Assignee: Electronics and Telecommunications Research Institute, Daejeon (KR)

(21) Appl. No.: 13/473,515

(22) Filed: May 16, 2012

(30) Foreign Application Priority Data
Sep. 19, 2011 (KR) 10-2011-0094309

(51) Int. Cl. G06F 15/177

(52) U.S. Cl. 709/221

(57) ABSTRACT

Disclosed are a system for sharing information between heterogeneous service providers, including: a first service provider configured to generate first situation information based on an abnormal situation of a system; a second service provider configured to receive the first situation information from the first service provider, generate second situation information corresponding to the received first situation information; and the TTP configured to receive the first situation information from the first service provider, receive the second situation information from the second service provider, generate correspondence information based on the received information, and share the generated correspondence information.

### CROSS-REFERENCE TO RELATED APPLICATIONS

This application claims priority to and the benefit of Korean Patent Application No. 10-2011-0094309 filed in the Korean Intellectual Property Office on Sep. 19, 2011, the entire contents of which are incorporated herein by reference.

### TECHNICAL FIELD

The present invention relates to a system for sharing information between heterogeneous service providers, and more particularly, to a system and method for sharing security information between heterogeneous service providers, in which information is shared for coping with cyber terrorism and information invasion in collaboration with other service providers on a network when an abnormal situation occurs in a system, for example, when external attack on security service providers occurs.

### BACKGROUND ART

The recent rapid development of the Internet meets a user's desire for information. Simultaneously, various types of new services have been generated based on the rapid development of the Internet and have been provided to users. However, as the adverse effects of such development, an information invasion problem, such as cyber terrorism, hacking, or viruses, has become social issues.

Therefore, information sharing and analysis centers or the like have been established and operated for effective joint response to cyber terrorism and information invasion, and mainly performs real-time alarming and analysis tasks.

However, in the collaborative response to information protection, such as establishment and operation of response systems for invasion accidents, stable information sharing should be carried out for information collection and application. However, limitations due to technical and legal problems have been pointed out.

Among the existing technologies, a Locasto method was proposed in 2005 by three persons, including Locasto. The Locasto method suggests requirements for a global collaboration method based on a P2P intrusion prevention system, and the Locasto method is a global collaboration method on a P2P-style overlay network under a distributed environment. However, the Locasto method has the following problems.

First, the Locasto method associates a relevant monitoring list as well as dynamic IP data, based on a one-way data structure, and provides the dynamic IP data and the relevant monitoring list, based on a mutual participation session, when privacy is required.

However, if a security service is provided as a mutual participation session only when an attach information event requires privacy in terms of real-time information sharing with respect to attack information, there is a problem in that safety of an existing attach information event is not guaranteed.

Second, the Locasto method has proposed interworking between security systems in a distributed form such as a P2P overlay network environment. However, this method has a vulnerability that it is difficult to interwork with different types of complicated security systems and it is difficult to interwork with nodes with respect to alarm data such as DHT-P2P. Since it is difficult to map limited types of nodes and contents, TTP is additionally required.

Third, the Locasto method allows the respective nodes to use pubic keys as verification values for distributed data and to verify new public data by the use of continuously associated public data. However, due to the characteristics of the P2P environment, the nodes are free to join and leave. While it is difficult to apply to a large-scale network, it is possible to apply to a small-scale network, causing an applicability problem.

As another existing technology, an ISAC method is a method that performs a financial vulnerability analysis and evaluation, a response to invasion accidents, hacking and cyber terrorism information collection, an analysis provision, or the like in the Financial Information Sharing and Analysis Center (ISAC).

As for the ISAC method, information is collected in a related site and is classified and analyzed through an agent. Then, a profile for search results and information for invasion response and technical response are generated in an information management server. Then, the profile and the information are notified to members and are revealed on a web page. However, the ISAC method has the following vulnerabilities.

First, the ISAC method notifies a Zero-Day attack to a user or administrator through a plaintext message (e-mail, SMS), and provides an information sharing policy. Therefore, confidentiality of illegal attack information events from unauthorized attackers cannot be guaranteed.

Second, the ISAC method reveals information sharing with a relevant agency on a web page and provides a service in a separate client/server structure. Therefore, a separate safe communication channel establishment is always required for prompt situation propagation and safe sharing of explicit authentication information.

Third, based on policy support for information sharing between different networks, the ISAC method performs a process of establishing an invasion response DB in the event of emergency, based on the collected information, and posting the invasion response DB on a homepage. However, in this process, since it is difficult to promptly confirm and share information on Zero-Day attack and hacking threat, a separate security policy service therefor is required.

### SUMMARY OF THE INVENTION

Recently, in regard to network invasion, problems caused because a variety of information about network attack and response between systems having independent security services is not shared is on the rise.

The present invention has been made in an effort to provide a method for sharing an attack information event through a trust third agency to stably share information between heterogeneous service providers for global collaboration on a network.

In particular, even though attack information is opened through a public channel, a trust third agency serves as a control tower in the event of emergency to issue a more active and positive policy and cope with the emergency.

An exemplary embodiment of the present invention provides a system for sharing information between heterogeneous service providers, including: a first service provider configured to generate first situation information based on an abnormal situation of a system and transmit the generated first situation information to outside; a second service provider configured to receive the first situation information from the first service provider, generate second situation information corresponding to the received first situation information, and transmit the second situation information to a trust third party (TTP); and the TTP configured to receive the first situation information from the first service provider, receive the second situation information from the second service provider, generate correspondence information based on the received information, and share the generated correspondence information.

The first service provider may include: a first encryption information generating unit configured to generate first encryption information by encrypting information on an abnormal situation of a system; a first unique information generating unit configured to generate first unique information based on the generated first encryption information and a time variant parameter (TS: time stamp) of the information on the abnormal situation; and a first situation information transmitting unit configured to generate first situation information, including the first encryption information, the TS of the information on the abnormal situation, and the first unique information, and transmit the first situation information.

The first encryption information generating unit may randomly select the information on the abnormal situation of the system and generate first encryption information using a public modulus and a representation function, and the first unique information generating unit may generate a hash value, to which a hash function is applied based on the first encryption information and the TS of the information on the abnormal situation, as the first unique information.

The second service provider may include: an information receiving unit configured to receive the first situation information from the first service provider and verify integrity of the first situation information; a second encryption information generating unit configured to generate second encryption information by encrypting correspondence information corresponding to the first situation information; a second unique information generating unit configured to generate second unique information based on the generated second encryption information and a TS of the correspondence information corresponding to the first situation information; and a second situation information transmitting unit configured to transmit second situation information, including the second encryption information, the TS of the correspondence information, and the second unique information.

The second encryption information generating unit may randomly select correspondence information capable of recovering or preventing an abnormal situation included in the first situation information, and generate the second encryption information using a public modulus and a representation function, and the second unique information generating unit may generate a hash value, to which a hash function is applied based on the second encryption information and the TS of the correspondence information, as the second unique information.

The TTP may include: an information receiving unit configured to receive the first situation information from the first service provider and receive the second situation information from the second service provider; an information verifying unit configured to verify integrity of the received first situation information and the received second situation information; a correspondence information generating unit configured to generate correspondence information based on the received first situation information and the received second situation information; and a correspondence information transmitting unit configured to transmit the correspondence information to the first service provider and the second service provider.

The correspondence information generating unit may generates correspondence information capable of recovering or preventing an abnormal situation included in the first situation information, based on the received first situation information, the received second situation information, a public key of the TTP, and a private key of the TTP.

The first first service provider may further include a service provider information sharing setting changing unit configured to receive correspondence information corresponding to first situation information, verify the received correspondence information, and change information sharing settings of the first service provider. The second service provider may further include a service provider information sharing setting changing unit configured to verify received correspondence information and change a information sharing stetting, when the correspondence information corresponding to the second situation information is received and shared.

The first service provider may further include a first secret communication unit configured to exchange a representation function of the first service provider with a representation function of the second service provider, generate a Diffie-Hellman (DH) session key, and perform a secret communication between the first service provider and the second service provider. The second service provider may further include a second secret communication unit configured to exchange a representation function of the second service provider with a representation function of the first service provider, generate a Diffie-Hellman (DH) session key, and perform a secret communication between the first service provider and the second service provider.

Another exemplary embodiment of the present invention provides a method for sharing information between heterogeneous service providers, including: generating, by a first service provider, first situation information based on an abnormal situation of a system of the first service provider; transmitting the first situation information generated by the first service provider to a second service provider and a trust third party (TTP); receiving correspondence information corresponding to the first situation information from the TTP; and changing, by the first service provider, an information sharing setting according to the correspondence information.

The generating of the first situation information may include: generating first encryption information by encrypting information on an abnormal situation of a system; generating first unique information based on the generated first encryption information and a time variant parameter (TS: time stamp) of the information on the abnormal situation; and generating first situation information, including the first encryption information, the TS of the information on the abnormal situation, and the first unique information, and transmitting the first situation information.

In the generating of the first encryption information, the information on the abnormal situation of the system may be randomly selected, and the first encryption information may be generated using a public modulus and a representation function. In the generating of the first unique information, a hash value, to which a hash function is applied based on the first encryption information and the TS of the information on the abnormal situation, may be generated as the first unique information.

The method may further include exchanging a representation function of the first service provider with a representation function of the second service provider, generating a Diffie-Hellman (DH) session key, and performing a secret communication.

Yet another exemplary embodiment of the present invention provides a method for sharing information between heterogeneous service providers, including: receiving, by a second service provider, first situation information from a first service provider; generating second situation information corresponding to the first situation information received by the second service provider, and transmitting the generated second situation information to the first service provider and a TTP; receiving correspondence information corresponding to the first situation information from the TTP; and changing, by the first service provider, an information sharing setting according to the correspondence information.

The receiving of the first situation information may further include verifying integrity of the received first situation information.

The generating of the second situation information may include: generating second encryption information by encrypting correspondence information corresponding to the received first situation information; generating second unique information based on the generated second encryption information and a time variant parameter (TS: time stamp) of the correspondence information; and generating second situation information, including the second encryption information, the TS of the correspondence information, and the second unique information, and transmitting the second situation information.

In the generating of the second encryption information, correspondence information capable of recovering or preventing an abnormal situation included in the received first situation information may be randomly selected, and the second encryption information may be generated using a public modulus and a representation function. In the generating of the second unique information, a hash value, to which a hash function is applied based on the second encryption information and the TS of the correspondence information, may be generated as the second unique information.

The method may further include exchanging a representation function of the first service provider with a representation function of the second service provider, generating a Diffie-Hellman (DH) session key, and performing a secret communication.

Still another exemplary embodiment of the present invention provides a method for sharing information between heterogeneous service providers, including: receiving, by a TTP, first situation information from a first service provider; receiving, by the TTP, second situation information from a second service provider; verifying integrity of the first situation information and the second situation information received by the TTP; generating correspondence information based on the first situation information and the second situation information received by the TTP; and transmitting, by the TTP, the correspondence information to the first service provider and the second service provider.

In the generating of the correspondence information, correspondence information capable of recovering or preventing an abnormal situation included in the first situation information may be generated based on the received first situation information, the received second situation information, a public key of the TTP, and a private key of the TTP.

According to exemplary embodiments of the present invention, as an integrated control service is provided by operating a system for sharing information between heterogeneous service providers, information of events generated during the operation of a plurality of management networks are managed and situations of the corresponding networks dare recognized and reflected on the entire networks. Therefore, information on network attacks and information on security states are further fragmented and simplified, and are then provided to users, improving the facilitation of management.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a system for sharing information between heterogeneous service providers according to an exemplary embodiment of the present invention.

FIG. 2 is a flowchart illustrating a method for sharing information between heterogeneous service providers with respect to a first service provider according to another exemplary embodiment of the present invention.

FIG. 3 is a flowchart illustrating a method for sharing information between heterogeneous service providers with respect to a second service provider according to yet another exemplary embodiment of the present invention.

FIG. 4 is a flowchart illustrating a method for sharing information between heterogeneous service providers with respect to a TTP according to still another exemplary embodiment of the present invention.

FIG. 5 is a reference diagram of a method for sharing information between heterogeneous service providers according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description, detailed descriptions of well-known functions or configurations will be omitted since they would unnecessarily obscure the subject matters of the present invention.

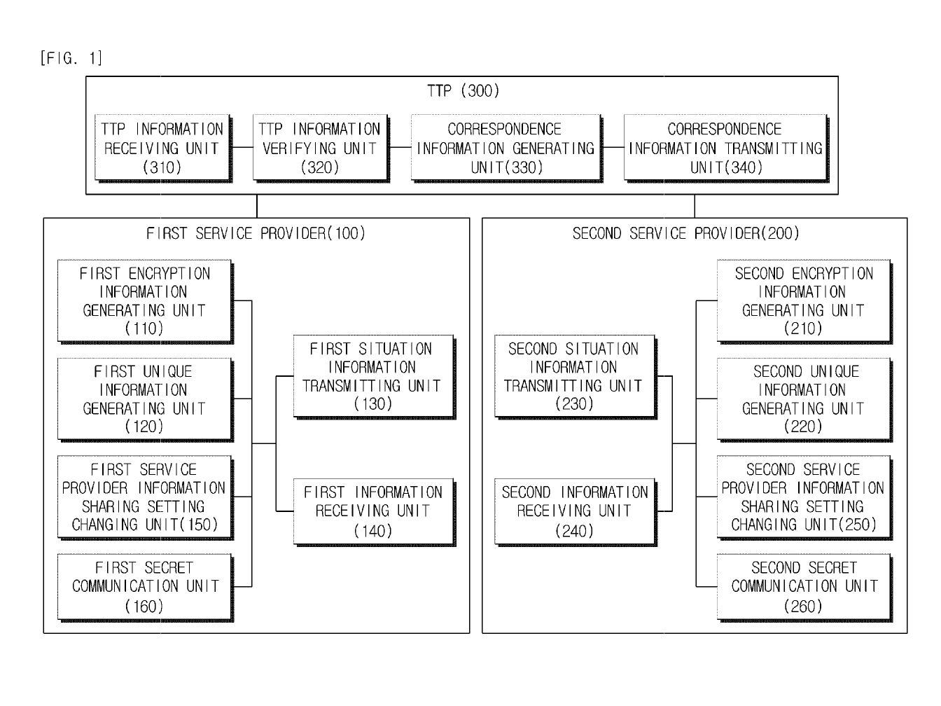

A system for sharing information between heterogeneous service providers according to an exemplary embodiment of the present invention will be described with reference to FIG. 1.

A first service provider 100 generates first situation information based on an abnormal situation of a system, and transmits the generated first situation information to the outside. The abnormal situation refers to a case in which a system cannot effectively respond to a user's request due to a generation of an event, which is not set on a system, such as a network invasion or a flood of abrupt data processing requests, or the like.

The first situation information refers to information composed of at least one parameter or flag to check an abnormal situation of the first service provider 100. According to an implementation example of the present invention, when the first situation information for network invasion information is generated, information including at least one of time of when a network invasion occurs, an IP trying to a network attack, position information of a network attacker, and network package information, which are analyzed through an existing network security system or product, may be included in the first situation information.

The first service provider 100 may include a first encryption information generating unit 110, a first unique information generating unit 120, a first situation information generating unit 130, and a first information receiving unit 140.

The first encryption information generating unit 110 generates first encryption information by encrypting information on the abnormal situation of the system. According to an implementation example of the present invention, the first encryption information generating unit 110 may generate information to be encrypted randomly among event information on the abnormal situation of the system, as expressed in Equation 1 below, and generate the first encryption information using a pubic modulus and a representation function. The public modulus is a value any one can search or view. The public modulus may be set arbitrarily. The representation function performs a specific function set by a user and may be set to encrypt specific information.

$$a \text{:} Information on abnormal situation ( a > 0 ) \\ z \text{:} Public modulus \\ t \text{:} Time stamp \\ A \text{:} Representation function \\ G \text{:} Representation function \\ {X}_{A} ( n ) = \{ \begin{matrix}1 & if n ∈ A \\ 0 & if n ∉ A\end{matrix} \\ {G}_{A} ( z ) = {\sum }_{a ∈ A}^{ } {z}^{a} = {\sum }_{a = A}^{ } \text{:} {X}_{A} ( n ) {z}^{n} \qquad [ Equation 1 ]$$

The first unique information generating unit 120 may first unique information based on the first encryption information generated by the first encryption information generating unit 110 and a time variant parameter (TS: time stamp) of the information on the abnormal situation. The first unique information refers to information having a unique value to verify integrity with respect to the abnormal situation of the system.

As an implementation example of the present invention, the first unique information generating unit 120 may generate a hash value, to which a hash function is applied based on the first encryption information and the time stamp (TS) of the information on the abnormal situation, as expressed in Equation 2 below, as the first unique information. The hash function refers to an equation expression of an algorithm for conversion into a value or key of a small length that can directly access an address to find one character string more quickly.

H: Hash function

G_{A}(Z): Encryption information

t: Time stamp

h_{A}=H(G_{A}(Z)∥t_{A}) [Equation 2]

The first situation information transmitting unit 130 may generate first situation information, including the first encryption information, the TS of the information on the abnormal situation, and the first unique information, and transmit the first situation information to the outside such as a different service provider on a network or a trust third party (TTP).

According to an exemplary embodiment of the present invention, the first service provider 100 may further include a first service provider information sharing setting changing unit 150 that receives correspondence information corresponding to the first situation information through the first information receiving unit 140 so as to share the correspondence information, verifies the received correspondence information, and changes an information sharing setting. The information sharing setting includes a range of public or private information of the service provider, or information modification for solving the abnormal situation.

According to an exemplary embodiment of the present invention, the first service provider 100 may further include a first secret communication unit 160 that exchanges the representation function of the first service provider 100 with a representation function of a second service provider 200 through a data communication, generates Diffie-Hellman (DH) session key, and performs a secret communication between the first service provider 100 and the second service provider 200.

The second service provider 200 receives the first situation information from the first service provider 100, generates second situation information corresponding to the received first situation information, and transmits the second situation information to a TTP. The second situation information refers to information that allows the second system to recover the abnormal situation of the system into the normal situation based on the first situation information, or prevents the abnormal situation.

The second service provider 200 may include a second encryption information generating unit 210, a second unique information generating unit 220, a second situation information transmitting unit 230, and a second information receiving unit 240.

The second information receiving unit 240 may receive the first situation information from the first service provider and verify integrity. The integrity means that information maintains consistency even after undergoing transmission, storage or conversion processes in data and network security. That is, the integrity means whether the same contents as those of original representation are transmitted to the other party. The integrity is a security service term meaning whether a message is not arbitrarily changed midway by a third party, et al. That is, the integrity is to change information only by an applied method to protect information from arbitrary change, change, insertion, or deletion.

An integrity checking method may use a cryptographic checksum or a cyclic redundancy check (CRC) to cope with a data transmission error, and may use a hash function, a message digest, MD5, or RC4 so as to cope with intentional arbitrary change. According to an exemplary embodiment of the present invention, the integrity may be checked using a hash value of the first unique information included in the first situation information.

The second encryption information generating unit 210 may generate second encryption information by encrypting correspondence information corresponding to the first situation information. According to an implementation example, the second encryption information generating unit 210 may randomly select correspondence information capable of recovering or preventing the abnormal situation included in the first situation information as expressed in Equation 3 below, and generate the second encryption information using a public modulus and a representation function. The correspondence information may be preset by a user or may be input. The correspondence information is information that recovers the abnormal situation based on the first situation information into the original state or prevent the abnormal situation.

$$b \text{:} Correspondence information of service provider based on information {}_{ }^{``}{a}{}_{ }^{″} on abnormal situation \\ B \text{:} Representation function \\ Z \text{:} Public modulus \\ {X}_{B} ( n ) = 1 - {X}_{A} ( n ) ( in all n ∈ N , {X}_{A} ( h ) = \{ \begin{matrix}1 & if n ∈ A \\ 0 & if n ∉ A\end{matrix} \\ {G}_{B} ( z ) = {\sum }_{b ∈ B }^{ } {z}^{b} = {\sum }_{n = 0}^{ } ( 1 - {X}_{A} ( n ) ) {z}^{n} = \frac{1}{1 - z} - {G}_{A} ( z ) \qquad [ Equation 3 ]$$

The second unique information generating unit 220 may generate the second unique information based on the generated second encryption information and the time stamp (TS) of the correspondence information corresponding to the first situation information.

According to an implementation example of the present invention, the second unique information generating unit 220 may generate a hash value, to which a hash function is applied based on the second encryption information and the time stamp (TS) of the correspondence information, as expressed in Equation 4 below, as the second unique information. The second unique information refers to information having a unique value that allows an external system to verify integrity with respect to the correspondence information of the second service provider.

H: Hash function

G_{A}(Z): Encryption information

t: Time stamp

h_{B}=H(G_{A}(Z)∥t_{B}) [Equation 4]

The second situation information transmitting unit 230 may transmit second situation information, including the second encryption information, the TS of the correspondence information, and the second unique information, to the TTP. That is, since the correspondence information corresponds to the first situation information, the second situation information transmitting unit 230 is configured to transmit the second situation information to the TTP to verify the first service provider.

According to an exemplary embodiment of the present invention, the second service provider 200 may further include a second service provider information sharing setting changing unit 250 that verifies received correspondence information and changes the information sharing stetting, when the correspondence information corresponding to the second situation information is received and shared.

According to an exemplary embodiment of the present invention, the second service provider 200 may further include a second secret communication unit 260 that exchanges the representation function of the second service provider 200 with the representation function of the first service provider 100, generates Diffie-Hellman (DH) session key, and performs a secret communication between the first service provider 100 and the second service provider 200.

The TTP 300 receives the first situation information from the first service provider 100 and receives the second situation information from the second service provider 200. The TTP 300 may generate the correspondence information based on the received first situation information and the received second situation information, and share the generated correspondence information. The TTP 300 may include a TTP information receiving unit 310, a TTP information verifying unit 320, a correspondence information generating unit 330, and a correspondence information transmitting unit 340.

The TTP information receiving unit 310 may receive situation information from an external system, and may transmit the received information to the TTP information verifying unit 320. According to an exemplary embodiment of the present invention, the TTP information receiving unit 310 may be set to receive the first situation information from the first service provider 100 and receive the second situation information from the second service provider 200.

The TTP information verifying unit 320 may verify integrity of the received information. According to an implementation example of the present invention, the integrity of information may be checked using the situation information. When unique information using a hash function is included in the situation information, the integrity of information may be checked using a hash value of the unique information. According to an implementation of the present invention, Equation 5 below is calculated and then verified.

$${\sum }_{n = 0}^{∞} {r}_{A , 2} ( n ) {z}^{n} = \frac{1}{2} ( {{G}_{A} ( z )}^{2} + {G}_{A} ( {z}^{2} ) ) , {\sum }_{n = 0}^{∞} {r}_{B , 2} ( n ) {z}^{n} \qquad [ Equation 5 ]$$

When the information is verified, the TTP calculates a corresponding private key pair as expressed in Equation 6 below.

$${\sum }_{n = 0}^{N - 1} ( 1 - {X}_{A} ( n ) - {X}_{A} ( 2 n ) ) {z}^{2 n} + {\sum }_{n = 0}^{N - 1} ( {X}_{A} ( n ) - {X}_{A} ( 2 n + 1 ) ) {z}^{2 n + 1} + {\sum }_{n = N}^{∞} ( 1 - {X}_{A} ( n ) - {X}_{A} ( 2 n ) ) {z}^{2 n} + {\sum }_{n = N}^{∞} ( {X}_{A} ( n ) - {X}_{A} ( 2 n + 1 ) ) {z}^{2 n + 1} \qquad [ Equation 6 ]$$

Therefore, the first service provider and the second service provider may share the abnormal situation.

The correspondence information generating unit 330 may generate the correspondence information capable of recovering or preventing the abnormal situation included in the first situation information, based on the received information. According to an exemplary embodiment of the present invention, the correspondence information generating unit 330 may generate the correspondence information, based on the received first situation information, the received second situation information, and the public key of the TTP, and the private key of the TTP.

e=<G_{A}(z), G_{B}(z), p_{T}t_{T}>

S_{T}=S_{qT}(<e>∥t_{T}) [Equation 7]

That is, since security systems between heterogeneous service providers are different in configuration, packet information, and the like, the TTP may generate and share the correspondence information based on a protocol commonly applicable to the first system and the second system.

The correspondence information transmitting unit 340 transmits the correspondence information generated by the correspondence information generating unit 330 to the first service provider 100 and the second service provider 200.

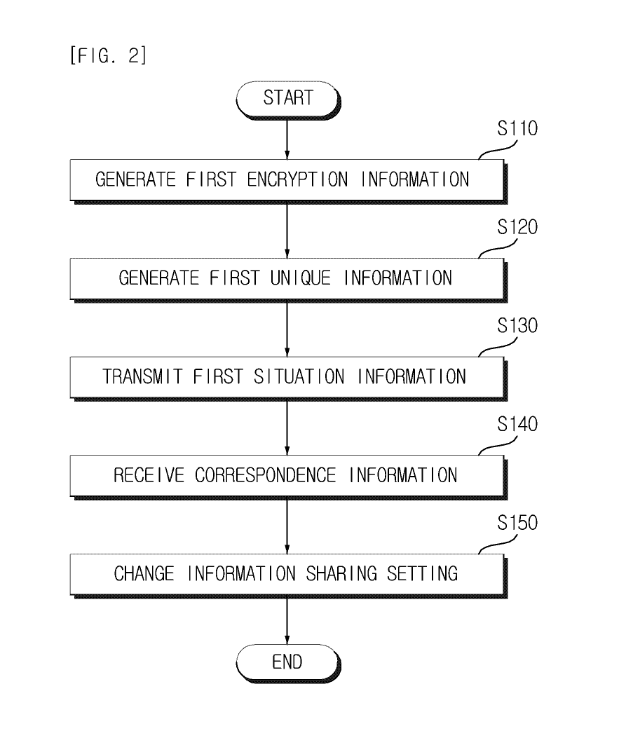

A method for sharing information between heterogeneous service providers according to another exemplary embodiment of the present invention will be described with reference to FIG. 2.

The first service provider may generate first situation information based on the abnormal situation of the system. The abnormal situation refers to a situation in which the system cannot effectively respond to a user's request, and the first situation information refers to information that can grasp the abnormal situation.

According to an exemplary embodiment of the present invention, a first encryption information generating step S110 may generate information to be encrypted randomly among event information on the abnormal situation of the system, and generate encryption information using a public modulus and a representation function.

A first unique information generating step S120 generates first unique information, based on the encryption information generated in the first encryption information generating step S110 and a time variant parameter (TS: time stamp) of the information on the abnormal situation. The time variant parameter refers to a parameter that is displayed to prove the occurrence fact of the information on the selected abnormal situation at a specific time such as the occurrence time of the information on the abnormal situation.

According to an exemplary embodiment of the present invention, the first unique information generating step S120 may generate a hash value, to which a hash function is applied based on the first encryption information and the TS of the information on the abnormal situation, as the first unique information.

A first situation information transmitting step S130 may generates and transmits first situation information, including the first encryption information, the TS of the information on the abnormal situation, and the first unique information. According to an exemplary embodiment of the present invention, the first service provider may transmit the generated first situation information to the second service provider and the TTP.

A correspondence information receiving step S140 may further include receiving correspondence information corresponding to the first situation information transmitted from the TTP and verifying integrity of the received correspondence information.

An information sharing setting changing step S150 may allow the first service provider to change information sharing setting according to the correspondence information received from the TTP.

According to an exemplary embodiment of the present invention, a secret communication setting step may be further included. The secret communication setting step may exchange a representation function of the first service provider with a representation function of the second service provider, generate a Diffie-Hellman (DH) session key, and perform a secret communication.

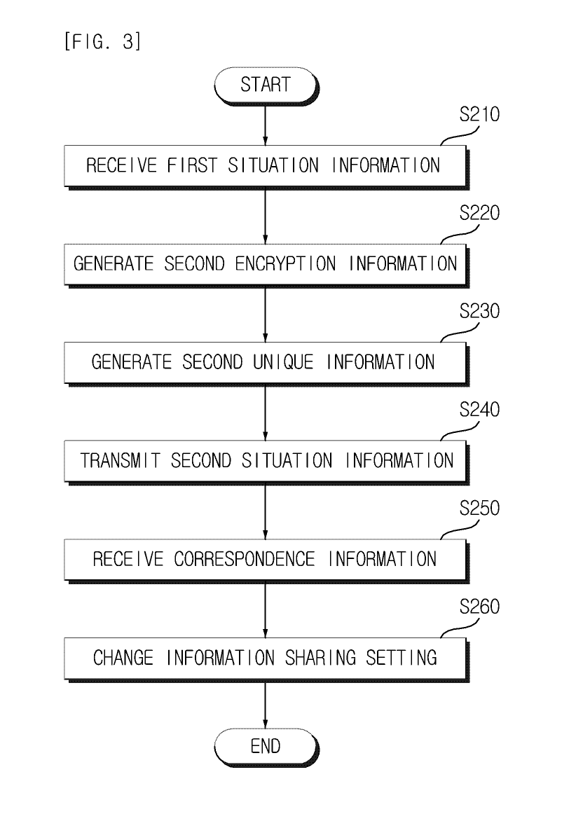

A method for sharing information between heterogeneous systems according to yet another exemplary embodiment of the present invention will be described with reference to FIG. 3.

A step in which the second service provider receives the first situation information from the first service provider may further include verifying integrity of the received first situation information. According to an exemplary embodiment of the present invention, the integrity verifying step may verify the integrity using a hash value of the first unique information included in the first situation information.

The second service provider may generate second situation information corresponding to the received first situation information, and transmit the generated second situation information to the first service provider and the TTP.

According to an exemplary embodiment of the present invention, the second situation information generating step may include a second encryption information generating step S220, a second unique information generating step S230, and a second situation information transmitting step S240.

The second encryption information generating step S220 may randomly select correspondence information capable of recovering or preventing the abnormal situation included in the received first situation information, and generate second encryption information using a public modulus and a representation function.

The second unique information generating step S230 may generate a hash value, to which a hash function is applied based on the generated second encryption information and the time variant parameter (TS: time stamp) of the correspondence information, as the second unique information.

The second situation information transmitting step S240 may transmit second situation information, including the second encryption information, the time stamp (TS) of the correspondence information, and the second unique information.

The correspondence information receiving step S250 may receive the correspondence information corresponding to the first situation information from the TTP and verify integrity of the first situation information.

The information sharing setting changing step S260 may allow the second service provider to change the information sharing setting of the second service provider according to the correspondence information.

According to an exemplary embodiment of the present invention, a secret communication setting step may be further included. The secret communication setting step may exchange the representation function of the first service provider with the representation function of the second service provider, generate a Diffie-Hellman (DH) session key, and perform a secret communication.

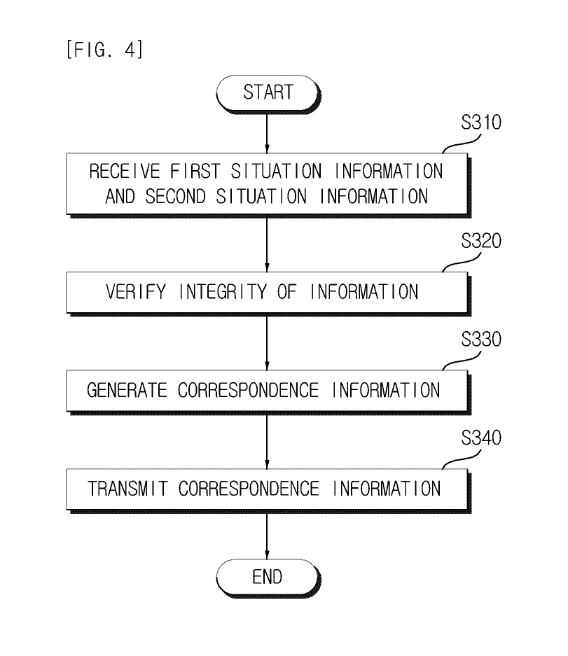

A method for sharing information between heterogeneous systems according to still another exemplary embodiment of the present invention will be described with reference to FIG. 4.

The trust third party or third agency (TTP) may receive first situation information from a first service provider and receive second situation information from a second service provider (S310).

The TTP may verify integrity of the received first situation information and the received second situation information (S320), and generate correspondence information based on the received first situation information and the received second situation information (S330). According to an exemplary embodiment of the present invention, the correspondence information generating step S330 generates correspondence information capable of recovering or preventing the abnormal situation included in the first situation information, based on the received first situation information, the received second situation information, a public key of the TTP, and a private key pair of the TTP.

The TTP includes a correspondence information transmitting step S340 of transmitting the generated correspondence information to the first service provider and the second service provider.

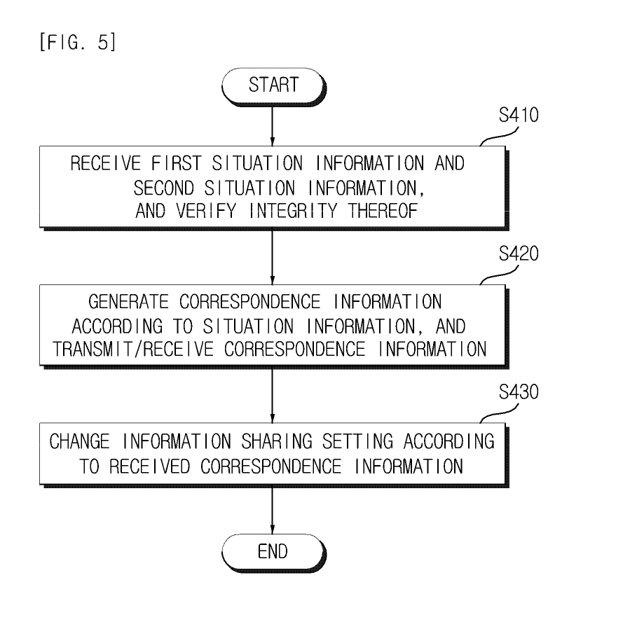

FIG. 5 is a reference diagram of a method for sharing information between heterogeneous service providers according to an exemplary embodiment of the present invention. When the first service provider generates situation information about abnormal situation and provides the situation information to the TTP and external service providers including the second service provider, the TTP and the external service provider receive first situation information, and the external service provider generates second situation information corresponding to the first situation information. The TTP further receives the second situation information, and the external service provider and the TTP verify integrity of the received situation information (S410).

The TTP generates correspondence information according to the situation information and transmits the generated correspondence information to the service providers, and the individual service providers receive the correspondence information generated by the TTP (S420).

The individual service providers changes the information sharing setting according to the received correspondence information. The information sharing setting may be changed by performing a secret communication between the individual service providers (S430).

Meanwhile, the exemplary embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for sharing information between heterogeneous service providers, comprising:
generating, by a first service provider, first situation information based on an abnormal situation of a system of the first service provider;
transmitting the first situation information generated by the first service provider to a second service provider and a trust third party (TTP);
receiving correspondence information corresponding to the first situation information from the TTP; and
changing, by the first service provider, an information sharing setting according to the correspondence information.

2. The method of claim 1, wherein the generating of the first situation information comprises:
generating first encryption information by encrypting information on an abnormal situation of a system;
generating first unique information based on the generated first encryption information and a time variant parameter (TS: time stamp) of the information on the abnormal situation; and
generating first situation information, including the first encryption information, the TS of the information on the abnormal situation, and the first unique information, and transmitting the first situation information.

3. The method of claim 2, wherein, in the generating of the first encryption information, the information on the abnormal situation of the system is randomly selected, and the first encryption information is generated using a public modulus and a representation function, and
in the generating of the first unique information, a hash value, to which a hash function is applied based on the first encryption information and the TS of the information on the abnormal situation, is generated as the first unique information.

4. A method for sharing information between heterogeneous service providers, comprising:
receiving, by a second service provider, first situation information from a first service provider;
generating second situation information corresponding to the first situation information received by the second service provider, and transmitting the generated second situation information to the first service provider and a TTP;
receiving correspondence information corresponding to the first situation information from the TTP; and
changing, by the first service provider, an information sharing setting according to the correspondence information.

5. The method of claim 4, wherein the receiving of the first situation information further comprises verifying integrity of the received first situation information.

6. The method of claim 4, wherein the generating of the second situation information comprises:
generating second encryption information by encrypting correspondence information corresponding to the received first situation information;
generating second unique information based on the generated second encryption information and a time variant parameter (TS: time stamp) of the correspondence information; and
generating second situation information, including the second encryption information, the TS of the correspondence information, and the second unique information, and transmitting the second situation information.

7. The method of claim 6, wherein, in the generating of the second encryption information, correspondence information capable of recovering or preventing an abnormal situation included in the received first situation information is randomly selected, and the second encryption information is generated using a public modulus and a representation function, and
in the generating of the second unique information, a hash value, to which a hash function is applied based on the second encryption information and the TS of the correspondence information, is generated as the second unique information.

8. A method for sharing information between heterogeneous service providers, comprising:
receiving, by a TTP, first situation information from a first service provider;
receiving, by the TTP, second situation information from a second service provider;
verifying integrity of the first situation information and the second situation information received by the TTP;
generating correspondence information based on the first situation information and the second situation information received by the TTP; and
transmitting, by the TTP, the correspondence information to the first service provider and the second service provider.

9. The method of claim 8, wherein, in the generating of the correspondence information, correspondence information capable of recovering or preventing an abnormal situation included in the first situation information is generated based on the received first situation information, the received second situation information, a public key of the TTP, and a private key of the TTP.

10. A system for sharing information between heterogeneous service providers, comprising:
a first service provider configured to generate first situation information based on an abnormal situation of a system and transmit the generated first situation information to outside;
a second service provider configured to receive the first situation information from the first service provider, generate second situation information corresponding to the received first situation information, and transmit the second situation information to a trust third party (TTP); and
the TTP configured to receive the first situation information from the first service provider, receive the second situation information from the second service provider, generate correspondence information based on the received information, and share the generated correspondence information.

11. The system of claim 10, wherein the first service provider comprises:
a first encryption information generating unit configured to generate first encryption information by encrypting information on an abnormal situation of a system;
a first unique information generating unit configured to generate first unique information based on the generated first encryption information and a time variant parameter (TS: time stamp) of the information on the abnormal situation; and
a first situation information transmitting unit configured to generate first situation information, including the first encryption information, the TS of the information on the abnormal situation, and the first unique information, and transmit the first situation information.

12. The system of claim 11, wherein the first encryption information generating unit randomly selects the information on the abnormal situation of the system and generates first encryption information using a public modulus and a representation function, and
the first unique information generating unit generates a hash value, to which a hash function is applied based on the first encryption information and the TS of the information on the abnormal situation, as the first unique information.

13. The system of claim 11, wherein the second service provider comprises:
an information receiving unit configured to receive the first situation information from the first service provider and verify integrity of the first situation information;
a second encryption information generating unit configured to generate second encryption information by encrypting correspondence information corresponding to the first situation information;
a second unique information generating unit configured to generate second unique information based on the generated second encryption information and a TS of the correspondence information corresponding to the first situation information; and
a second situation information transmitting unit configured to transmit second situation information, including the second encryption information, the TS of the correspondence information, and the second unique information.

14. The system of claim 13, wherein the second encryption information generating unit randomly selects correspondence information capable of recovering or preventing an abnormal situation included in the first situation information, and generates the second encryption information using a public modulus and a representation function, and
the second unique information generating unit generates a hash value, to which a hash function is applied based on the second encryption information and the TS of the correspondence information, as the second unique information.

15. The system of claim 10, wherein the TTP comprises:
an information receiving unit configured to receive the first situation information from the first service provider and receive the second situation information from the second service provider;
an information verifying unit configured to verify integrity of the received first situation information and the received second situation information;
a correspondence information generating unit configured to generate correspondence information based on the received first situation information and the received second situation information; and
a correspondence information transmitting unit configured to transmit the correspondence information to the first service provider and the second service provider.

16. The system of claim 15, wherein the correspondence information generating unit generates correspondence information capable of recovering or preventing an abnormal situation included in the first situation information, based on the received first situation information, the received second situation information, a public key of the TTP, and a private key of the TTP.

17. The system of claim 16, wherein the service providers further comprise a service provider information sharing setting changing unit configured to receive correspondence information corresponding to situation information from a TTP, verify the received correspondence information, and change information sharing settings of the service providers.
